(19) United States
(12) Patent Application Publication
(10) Pub. No.: US 2011/0157009 A1
(43) Pub. Date: Jun. 30, 2011

(54) DISPLAY DEVICE AND CONTROL METHOD THEREOF

(76) Inventors: Sungun Kim, Seoul (KR); Soungmin Im, Seoul (KR)

(21) Appl. No.: 12/979,838

(22) Filed: Dec. 28, 2010

(30) Foreign Application Priority Data
Dec. 29, 2009 (KR) 10-2009-0133171

(51) Int. Cl. G09G 5/00

(52) U.S. Cl. 345/156

(57) ABSTRACT

A display device and a control method thereof are provided. The display device comprises a camera obtaining an image including a gesture of a user and a controller extracting the image of the gesture from the obtained image and executing a function mapped to the extracted gesture when the range of the gesture exceeds a threshold corresponding to the user. The method of controlling the display device executes functions respectively corresponding to specific gestures of users when the gestures exceed thresholds respectively corresponding to the users to operate the display device in a manner most suitable for the range of the gesture of each user.

This application claims the benefit of Korean Patent Application No. 10-2009-0133171 filed on 29 Dec. 2009 which are hereby incorporated by reference.

### BACKGROUND

1. Field

This document relates to a display device and a control method thereof and, more particularly, to a display device and a control method thereof to execute functions respectively corresponding to specific gestures of users when the gestures exceed thresholds respectively corresponding to the users to operate the display device in a manner most suitable for the range of the gesture of each user.

2. Related Art

As the functions of terminals such as personal computers, laptop computers, cellular phones and the like are diversified, the terminals are constructed in the form of a multimedia player having multiple functions of capturing pictures or moving images, playing music, moving image files and games and receiving broadcasting programs.

A terminal as a multimedia player can be referred to as a display device since it generally has a function of displaying video information.

Terminals can be divided into a mobile terminal and a stationary terminal. Examples of the mobile terminal can include laptop computers, cellular phones, etc. and examples of the stationary terminal can include television systems, monitor for desktop computers, etc

### SUMMARY

An aspect of this document is to provide a display device and a control method thereof to execute functions respectively corresponding to specific gestures of users when the gestures exceed thresholds respectively corresponding to the users to operate the display device in a manner most suitable for the range of the gesture of each user.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a block diagram of a display device relating to an embodiment of this document;

FIG. 2 is a flowchart illustrating an operation of the display device shown in FIG. 1;

FIG. 3 is a view for explaining the operation of the display device shown in FIG. 2;

FIG. 4 is a flowchart illustrating an operation of acquiring information on the body shape of a user, shown in FIG. 2;

FIGS. 5, 6 and 7 are views for explaining an operation of acquiring body shape information of a user according to a first embodiment of this document;

FIG. 8 is a view for explaining an operation of acquiring body shape information of a user according to a second embodiment of this document;

FIG. 9 is a view for explaining an operation of acquiring body shape information of a user according to a third embodiment of this document;

FIG. 10 is a view for explaining an operation of acquiring body shape information of a user according to a fourth embodiment of this document;

FIGS. 11 and 12 are views for explaining an operation of acquiring body shape information of a user according to a fifth embodiment of this document;

FIG. 13 is a flowchart illustrating an operation of extracting a user's gesture from a captured image and comparing the extracted gesture to body shape information, shown in FIG. 2, in detail;

FIGS. 14 and 15 are views for explaining the operation of the display device according to the operation shown in FIG. 13;

FIGS. 16, 17 and 18 are views for explaining an operation of executing a function mapped to a gesture; and

FIGS. 19, 20 and 21 are views for explaining an operation of executing a function mapped to a user's gesture, shown in FIG. 2.

### DETAILED DESCRIPTION

This document will now be described more fully with reference to the accompanying drawings, in which exemplary embodiments of this document are shown. This document may, however, be embodied in many different forms and should not be construed as being limited to the embodiments set forth herein; rather, there embodiments are provided so that this disclosure will be thorough and complete, and will fully convey the concept of this document to those skilled in the art.

Hereinafter, a mobile terminal relating to this document will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

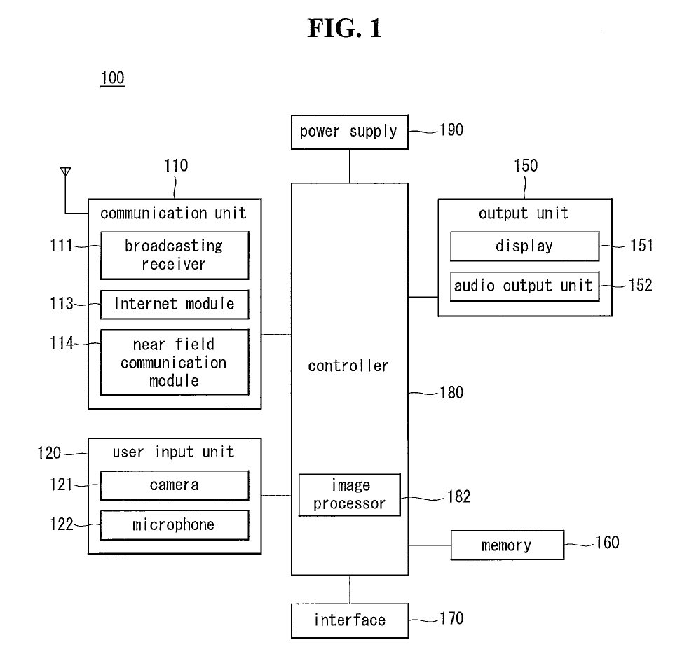

FIG. 1 is a block diagram of a display device relating to an embodiment of this document.

As shown, the display device 100 may include a communication unit 110, a user input unit 120, an output unit 150, a memory 160, an interface 170, a controller 180, and a power supply 190. Not all of the components shown in FIG. 1 may be essential parts and the number of components included in the display device 100 may be varied.

The communication unit 110 may include at least one module that enables communication between the display device 100 and a communication system or between the display device 100 and another device. For example, the communication unit 110 may include a broadcasting receiving module 111, an Internet module 113, and a near field communication module 114.

The broadcasting receiving module 111 may receive broadcasting signals and/or broadcasting related information from an external broadcasting management server through a broadcasting channel.

The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal. The broadcasting signals may include not only TV broadcasting signals, radio broadcasting signals, and data broadcasting signals but also signals in the form of a combination of a TV broadcasting signal and a radio broadcasting signal of a data broadcasting signal.

The broadcasting related information may be information on a broadcasting channel, a broadcasting program or a broadcasting service provider, and may be provided even through a communication network.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. The broadcasting signals and/or broadcasting related information received through the broadcasting receiving module 111 may be stored in the memory 160.

The Internet module 113 may correspond to a module for Internet access and may be included in the display device 100 or may be externally attached to the display device 100.

The near field communication module 114 may correspond to a module for near field communication. Further, Bluetooth®, radio frequency identification (RFID), infrared data association (IrDA), ultra wideband (UWB) and/or ZigBee® may be used as a near field communication technique.

The user input 120 is used to input an audio signal or a video signal and may include a camera 121 and a microphone 122.

The camera 121 may process image frames of still images or moving images obtained by an image sensor in a video telephony mode or a photographing mode. The processed image frames may be displayed on a display 151. The camera 121 may be a 2D or 3D camera. In addition, the camera 121 may be configured in the form of a single 2D or 3D camera or in the form of a combination of the 2D and 3D cameras.

The image frames processed by the camera 121 may be stored in the memory 160 or may be transmitted to an external device through the communication unit 110. The display device 100 may include at least two cameras 121.

The microphone 122 may receive an external audio signal in a call mode, a recording mode or a speech recognition mode and process the received audio signal into electric audio data. The microphone 122 may employ various noise removal algorithms for removing or reducing noise generated when the external audio signal is received.

The output unit 150 may include the display 151 and an audio output module 152.

The display 151 may display information processed by the display device 100. The display 151 may display a user interface (UI) or a graphic user interface (GUI) relating to the display device 100. In addition, the display 151 may include at least one of a liquid crystal display, a thin film transistor liquid crystal display, an organic light-emitting diode display, a flexible display and a three-dimensional display. Some of these displays may be of a transparent type or a light transmissive type. That is, the display 151 may include a transparent display. The transparent display may include a transparent liquid crystal display. The rear structure of the display 151 may also be of a light transmissive type. Accordingly, a user may see an object located behind the body of terminal through the transparent area of the terminal body, occupied by the display 151.

The display device 100 may include at least two displays 151. For example, the display device 100 may include a plurality of displays 151 that are arranged on a single face at a predetermined distance or integrated displays. The plurality of displays 151 may also be arranged on different sides.

Further, when the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 can detect a touched portion of the display 151.

The audio output module 152 may output audio data received from the radio communication unit 110 or stored in the memory 160. The audio output module 152 may output audio signals related to functions, such as a call signal incoming tone and a message incoming tone, performed in the display device 100.

The memory 160 may store a program for operation of the controller 180 and temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk or an optical disk. The display device 100 may also operate in relation to a web storage performing the storing function of the memory 160 on the Internet.

The interface 170 may serve as a path to all external devices connected to the mobile terminal 100. The interface 170 may receive data from the external devices or power and transmit the data or power to internal components of the display device terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The controller 180 may control overall operations of the mobile terminal 100. For example, the controller 180 may perform control and processing for voice communication. The controller 180 may also include an image processor 182 for pressing image, which will be explained later.

The power supply 190 receives external power and internal power and provides power required for each of the components of the display device 100 to operate under the control of the controller 180.

Various embodiments described in this document can be implemented in software, hardware or a computer readable recording medium. According to hardware implementation, embodiments of this document may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the controller 180 in some cases.

According to software implementation, embodiments such as procedures or functions may be implemented with a separate software module executing at least one function or operation. Software codes may be implemented according to a software application written in an appropriate software language. The software codes may be stored in the memory 160 and executed by the controller 180.

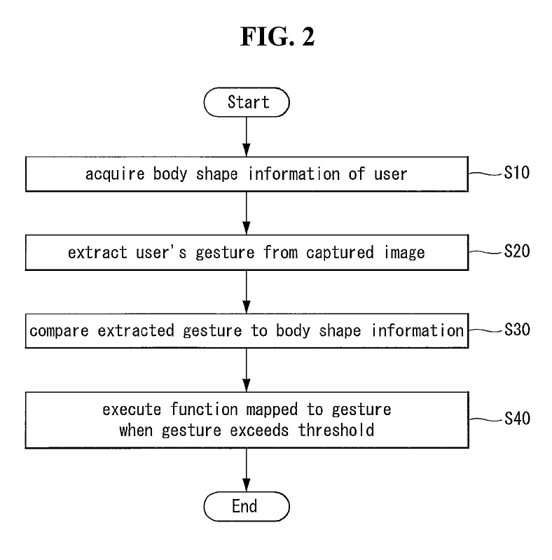

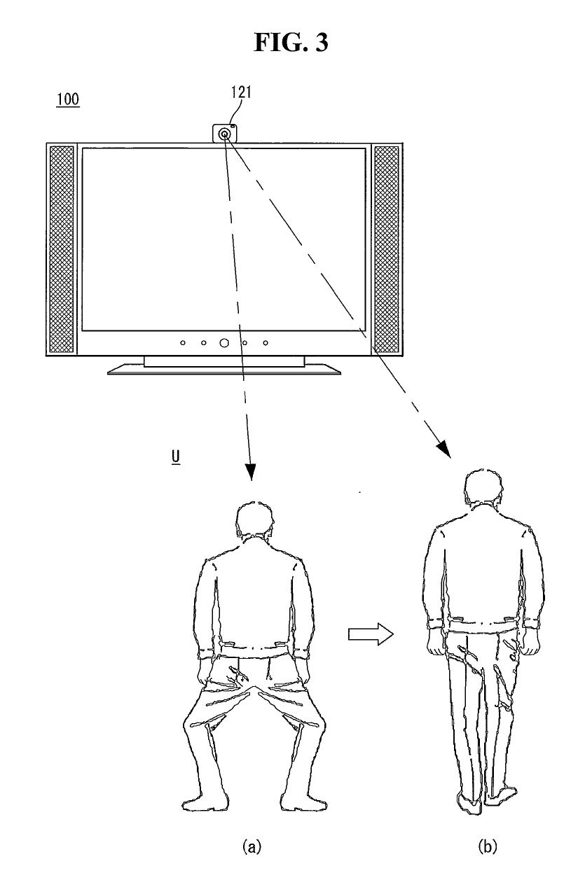

FIG. 2 is a flowchart illustrating an operation of the display device shown in FIG. 1 and FIG. 3 is a view for explaining the operation of the display device, shown in FIG. 2.

As shown, the display device 100 may acquire information on the body shape of a user U in step S10. The body shape information may be acquired based on an image obtained from the camera 121 included in the display device 100. That is, when the camera 121 captures an image of the user U, the obtained image is analyzed to acquire the body shape information of the user U. According to other embodiments of this document, the body shape information can be obtained without using the camera 121, which will be explained in detail later in the other embodiments.

Upon the acquisition of the body shape information, the image processor 182 included in the controller 180 shown in FIG. 1 can determine the current gesture of the user U. For example, the user U may make a sitting gesture, as shown in FIG. 3 (a), or make a standing gesture, as shown in FIG. 3 (b). When the user U makes a specific gesture, the image processor 182 shown in FIG. 1 is required to know the body shape information of the user U to determine the current gesture of the user U because the user U can be a small child or a tall adult. That is, the user U can have various body shapes and, if a user's gesture is determined based on a specific body shape, the user's gesture may not be correctly recognized. When a reference value is set based on a tall adult and a user's gesture is determined based on the reference value, for example, if a tall adult user makes a gesture, the display device 100 can correctly recognize this gesture. However, if a small child makes a sitting gesture and this gesture is determined based on the same reference value, the gesture may not be correctly recognized due to a variation in the gesture is small. Furthermore, when a reference value is set based on a short adult and a user's gesture is determined according to the reference value, the range of the gesture made by the tall adult may be recognized to be excessively large and thus the gesture can be wrongly recognized.

Body shape information may be set based on the actual body shape of each user. The actual body shape of the user U can be acquired in an initial stage in which the display device 100 is operated through the camera 121, acquired through the camera 121 while the user U uses the display device 100, or acquired in such a manner that the user U personally inputs his/her body shape information to the display device 100. Though the body shape information is obtained prior to other operations in FIG. 2, the time and method of acquiring the body shape information are not limited.

A user's gesture may be extracted from the image captured by the camera 121 in step S20.

The image of the user U, captured by the camera 121 set in or connected to the display device 100, may include a background image. If the image is photographed indoors, for example, the image can have furniture as the background of the user U. The user's gesture can be obtained by excluding the background image from the image.

The extracted user's gesture may be compared with the extracted body shape information to determine the user's gesture in step S30.

The user's gesture and the body shape information may be acquired through the above operations, and thus the user's gesture and the body shape information can be compared to each other.

When it is determined that the user's gesture exceeds a threshold from the comparison result, a function mapped to the gesture may be executed in step S40.

The threshold can be set based on the body shape information of the user U. The controller 180 shown in FIG. 1 may determine that the user's gesture is valid if the user's gesture exceeds the threshold set for the user U. The threshold can prevent an ordinary motion of the user U from being misrecognized as a specific gesture to cause a wrong operating of the display device 100. For example, a user's gesture of raising up the left arm to the left can be mapped to a function of changing the channel of the display device 100. The user can raise up or lower the left arm unconsciously in daily life. If the threshold is not set, even the unconscious motion of the user U can change the channel of the display device 100. That is, the threshold can be a reference value set to prevent the display device 100 from a wrong operation.

The threshold may be an appropriate or inappropriate value according to standard. For example, if the threshold is set based on a tall adult, a gesture of a small child can be recognized as a gesture that does not reach the threshold. Accordingly, the channel of the display device 100 may not be changed even when the small child raises up the left arm with the intention of changing the channel of the display device 100. On the contrary, when the threshold is set based on the small child, the channel of the display device 100 may be changed even when a tall adult slightly raises up the left arm unconsciously. Accordingly, it is required to set an appropriate threshold to prevent the display device 100 from a wrong operation.

In the current embodiment of this document, the threshold may be set based on the body shape information of the user U of the display device 100. The body shape information has been acquired in the above operation S10. The controller 180 shown in FIG. 1 can set a threshold for each user based on the acquired body shape information. For example, the controller 180 shown in FIG. 1 can set a relatively large threshold when the user U is an adult having a big frame and can set a relatively small threshold when the user U is a small child. The threshold can be set using mass profile analysis, guide point, modeling technique or acquired height information of the user U, which will be described in detail later. According to the present embodiment, the threshold can be set depending on the user U, and thus a wrong operation of the display device 100 due to misrecognition can be reduced.

A mapped function is a specific function corresponding to a specific gesture. For example, a user's gesture of raising up the left arm to the left can be mapped to the function of changing the channel of the display device 100, as described above. Since a specific gesture of the user U is mapped to a specific function, an additional device for controlling the display device 100, such as a remote controller, may not be needed. This can improve the convenience of use.

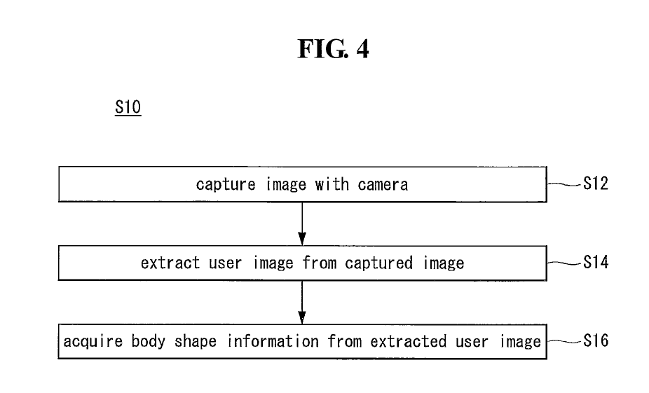

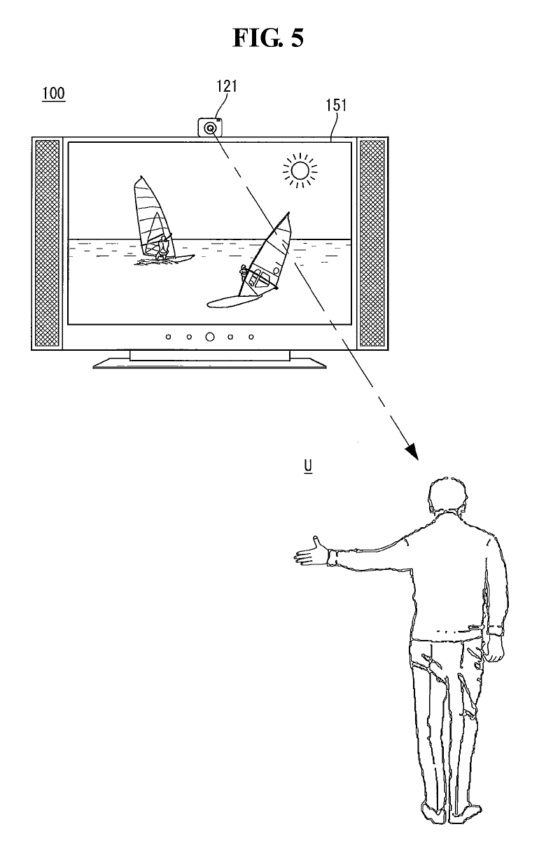

FIG. 4 is a flowchart illustrating the operation S10 of acquiring the body shape information of the user U, shown in FIG. 2, in detail and FIGS. 5, 6 and 7 are views for explaining an operation of acquiring the body shape information of the user U in the display device 100 according to a first embodiment of this document.

As shown, the operation S10 of acquiring the body shape information of the user U, shown in FIG. 2, may include an operation S12 of taking a picture of the user U using the camera 121.

Preliminary data for determining the body shape of the user U can be acquired using the camera 121 in the present embodiment. That is, the body shape information of the user U can be extracted from the image captured by the camera 121.

Referring to FIG. 5, the camera 121 can take an image of the user U while the display device 100 performs its own operation. The image of the user U may be extracted from the image taken by the camera 121 in step S14.

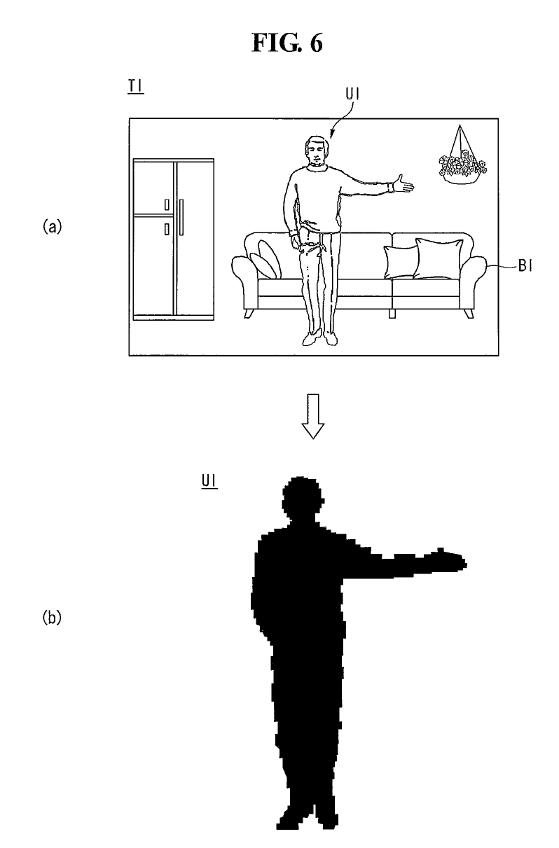

Referring to FIG. 6 (a), the image TI taken by the camera 121 may include the user image UI and a background image BI. In this case, it is required to extract the user image UI from the taken image TI.

Referring to FIG. 6 (b), the user image UI may be extracted from the taken image TI. The user image UI can be extracted using various image processing techniques. FIG. 6 (b) shows that the user image UI is extracted using contour extraction. Specifically, when the taken image TI includes a person, the user image UI can be extracted based on characteristics of the person. For example, the user image UI can be extracted from the taken image TI using the round head shape, the shape of the neck extended from the round head, shoulder line extended from the neck, and arm shape. The display device 100 according to the present embodiment can acquire the body shape information using the user image UI if the user image UI represents the general figure of the user U. Accordingly, it can be expected to reduce load required for the image processor 182 and the controller 180 shown in FIG. 1 to process images.

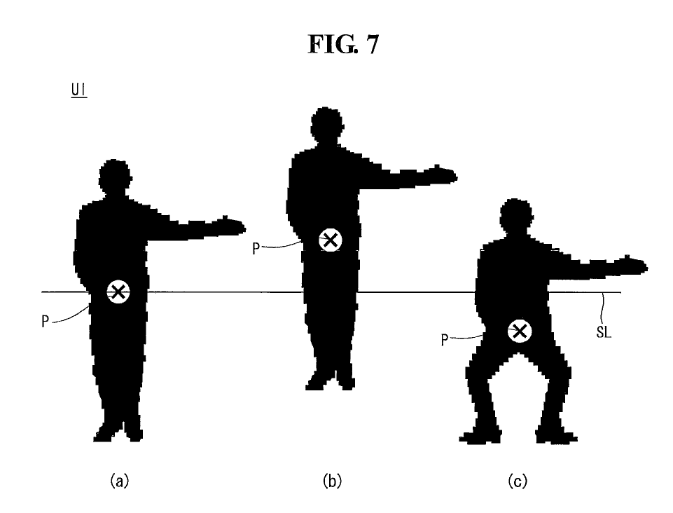

Referring to FIG. 7, the controller 180 shown in FIG. 1 can recognize the user's gesture through mass profile analysis of the user image UI included in the taken image TI. Specifically, the area of the distribution of the user image UI is calculated to detect the current center of mass P. The center of mass P means a point at which the area of the upper part of the user image UI, obtained when the calculation is performed starting from the head to the feet, becomes equal to the area of the lower part of the user image UI, obtained when the calculation is carried out starting from the feet to the head. The area distribution equilibrates at the center of mass P.

Referring to FIG. 7 (a), the user makes a gesture of standing upright. In this case, the center of mass P calculated based on the user image UI can be set to a specific point. For example, the center of mass P of the user U standing upright can be calculated to be a point near the abdomen of the user U if the user's weight is continuously distributed. The controller 180 shown in FIG. 1 can set the center of mass P of the user U standing upright as the threshold and set a virtual reference line SL on the horizontal plane based on the center of mass P. When the center of mass P and the reference line SL are set for the specific user U, the controller 180 shown in FIG. 1 can recognize user's following gestures by tracing the center of mass P.

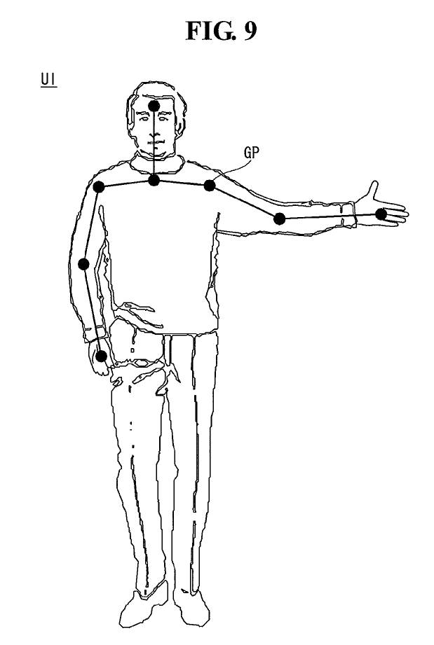

Referring to FIG. 9 (b), the controller 180 shown in FIG. 1 may recognize a specific instant of time when the center of mass P is moved above the reference line SL while tracing the center of mass P. In this case, the controller 180 shown in FIG. 1 can determine that the user U jumps without performing an additional analysis and calculation. That is, if the center of mass P when the user U stands upright, shown in FIG. 7 (a), is moved above the reference line SL, the controller 180 shown in FIG. 1 can determine that the user U jumps in place.

Referring to FIG. 7 (c), the controller 180 shown in FIG. 1 may recognize a specific instant of time when the center of mass P is moved below the reference line SL while tracing the center of mass P. In this case, the controller 180 shown in FIG. 1 can determine that the user U sits down in place. As described above, if the mass distribution of the user image UI at a specific instant of time is analyzed, user's gestures made after the specific instant of time can be analyzed without having an additional image analysis. Although the user's jumping or sitting gesture is exemplified in the present embodiment, a gesture of an arm or a gesture of a leg can be easily recognized if the center of mass P is set on the arm or leg.

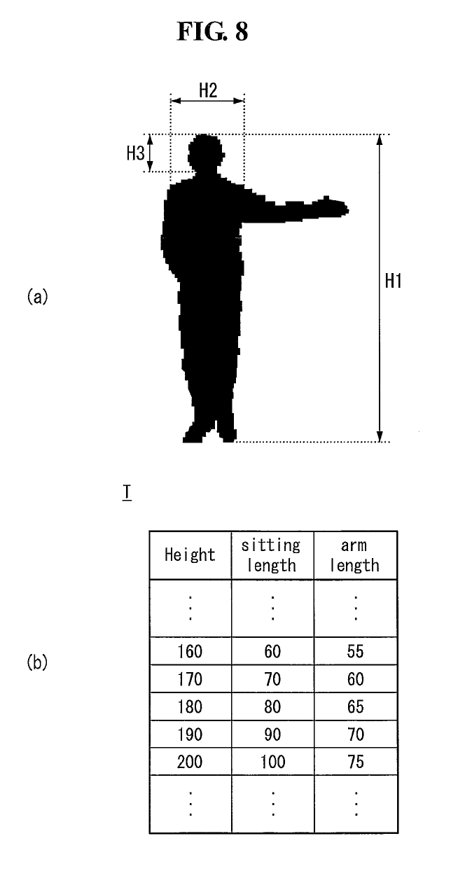

FIG. 8 is a view for explaining an operation of acquiring the body shape information of the user according to a second embodiment of this document.

As shown, the body shape information of the user can be directly acquired from the user image UI in the current embodiment of this document.

Referring to FIG. 8 (a), the body shape of the user can be measured from the extracted user image UI. Specifically, it is possible to know the height H1 of the user if an image of the standing user is taken. Furthermore, the shoulder width H2 and the head size H3 of the user can be also measured if required. If the shoulder width H2 and the head size H3 are detected, body shape information about other body parts can be obtained by comparing the shoulder width H2 and the head size H3 to a standard body shape table T shown in FIG. 8 (b). The shoulder width H2 or the head size H3 can be measured even when the user does not stand upright, and thus the method using the shoulder width He and/or the head size H3 can be applied more flexibly than the method of acquiring the height H1 of the user.

Referring to FIG. 8 (b), if the height H1 is measured, it is possible to know the standard body size of a person corresponding to the height H1 measured as described above. The memory 160 shown in FIG. 1 may store the standard body size table T. If it is difficult to store various body shape information items, only information on a most general height, a user's sitting length and arm length corresponding to the most general height is stored in the memory 160 shown in FIG. 1 and body shape information corresponding to other heights can be acquired by multiplying corresponding values stored in the table T by specific constants.

FIG. 9 is a view for explaining an operation of acquiring the body shape information of the user according to a third embodiment of this document. As shown, the display device 100 can acquire the body shape information of the user through a method of setting gesture points GP.

The controller 180 shown in FIG. 1 can set the gesture points GP on joints of the user U, as shown in FIG. 9. The controller 180 shown in FIG. 1 can relatively easily recognize the joints by tracing user images about several gestures. When the gesture points GP are set, body shape information such as an arm length can be acquired based on the distance between neighboring gesture points GP. Furthermore, the current gesture of the user can be recognized by tracing changes in relative positions of the gesture points GP.

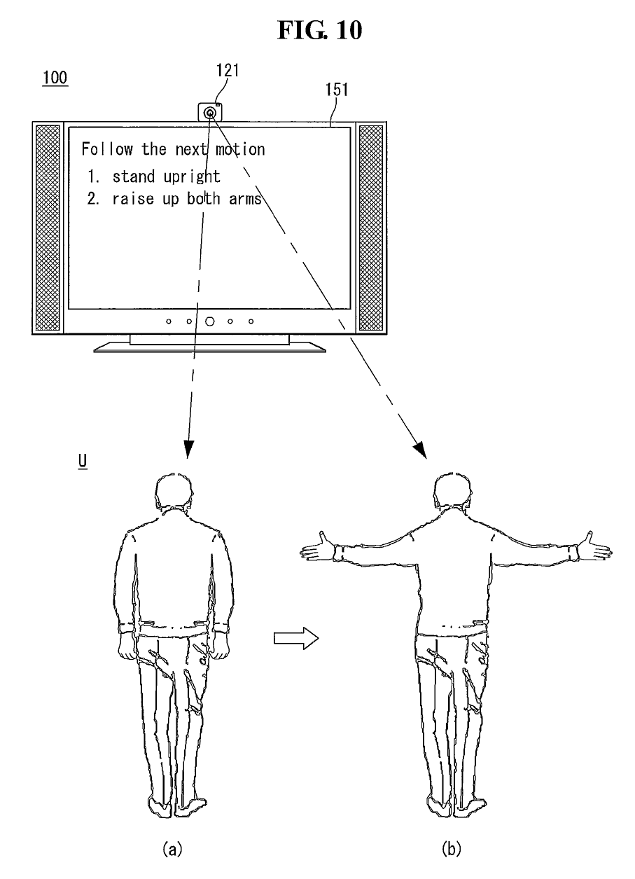

FIG. 10 is a view for explaining an operation of acquiring the body shape information of the user in the display device 100 according to a fourth embodiment of this document. The display device 100 can direct the user U to make a specific gesture to acquire the body shape information of the user U.

Referring to FIG. 10, the display device 100 may direct the user U to make a specific gesture through the display 151. For example, the display device 100 can direct the user U to stand upright and then order him/her to raise up both arms.

The controller 180 shown in FIG. 1 can analyze an image of the user U, captured through the camera 121, to measure the height of the user U at the instant of time the user U stands upright. In addition, the controller 180 shown in FIG. 1 can measure the arm length of the user U at the instant of time the user U raises up both arms. The display device 100 in the present embodiment is distinguished form the other embodiments in that the body shape information of the user U is acquired before the user U controls the display device 100 through a gesture.

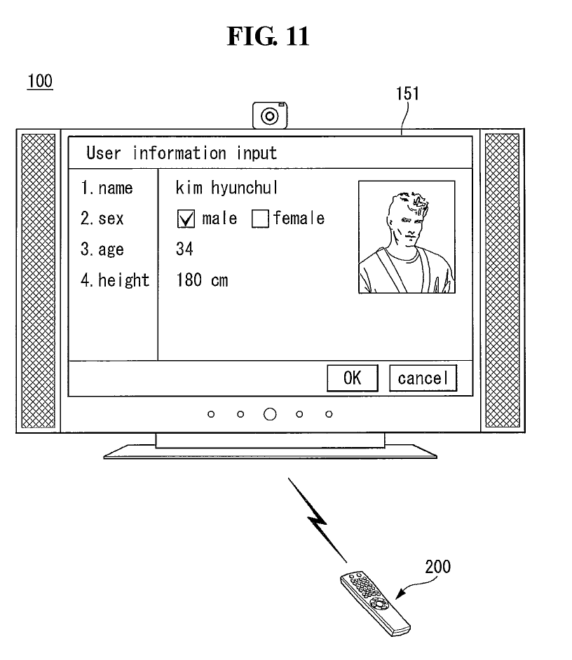

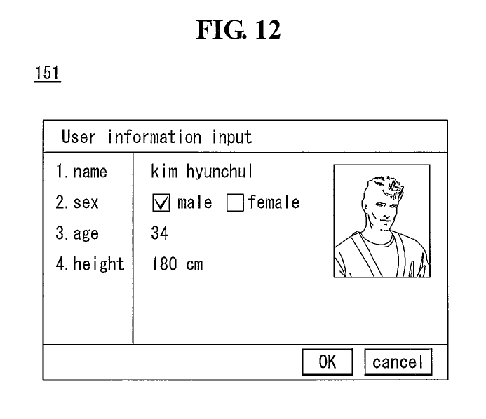

FIGS. 11 and 12 are views for explaining an operation of acquiring the body shape information of the user in the display device 100 according to a fifth embodiment of this document. As shown, the display device 100 can acquire the body shape information personally inputted by the user.

Referring to FIG. 11, the display device 100 can receive information through an external device such as a remote controller 200. When the display device 151 is configured in the form of a touch screen, the controller 180 shown in FIG. 1 can obtain required information from a touch signal applied to the display 151.

Referring to FIG. 12, the display 151 may display the information personally inputted by the user U. If the user inputs information about his/her height, the controller 180 shown in FIG. 1 can generate the body shape information of the user based on the height of the user.

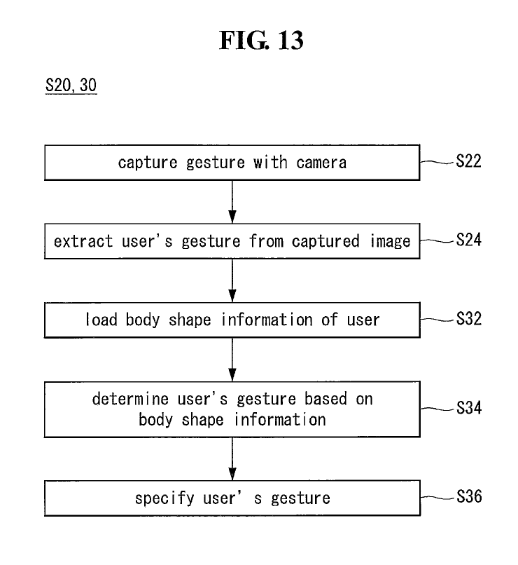

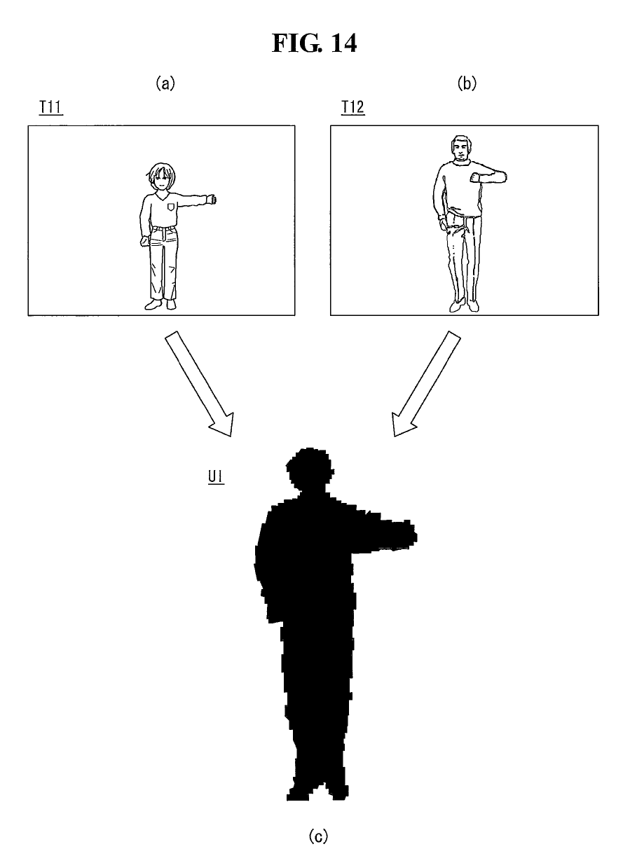

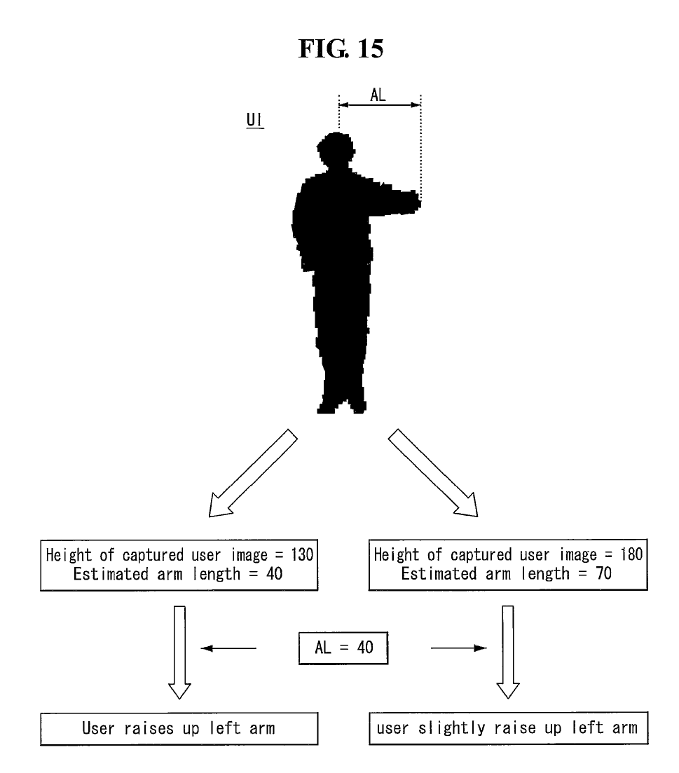

FIG. 13 is a flowchart illustrating the operation S20 of extracting the user's gesture from the captured image and the operation S30 of comparing the user's gesture to the body shape information, shown in FIG. 2, in detail and FIGS. 14 and 15 are views for explaining an operation of the display 100 according to the operations shown in FIG. 13.

As shown, the operation S20 of extracting the user's gesture from the image captured by the camera 121 and the operation S30 of comparing the extracted user's gesture to the body shape information may include an operation S22 of capturing the user's gesture through the camera 121 and a step S24 of extracting the user's gesture from the captured image.

The operations S22 and S24 of taking images of the user U and extracting the user image UI from the taken images TI1 and TI2 are identical to the aforementioned operations. However, the operations S22 and S24 will now be described for gestures that are made by different users but recognized to be identical.

Referring to FIG. 14 (a), a first image TI1 of a relatively small child who raises up the left arm can be captured through the camera 121. Referring to FIG. 14 (b), a second image TI2 of a relatively tall adult who half raises up the left arm can be captured through the camera 121.

The first and second taken images TI1 and TI2 are different from each other, and thus it can be considered that the two users make their gestures with different intentions. In other words, while there is quite a possibility that the user corresponding to the first taken image TI1 makes the gesture with the intention of executing a specific function, there is a high possibility that the user corresponding to the second taken image TI2 makes an accidental gesture. However, user images respectively extracted from the first and second taken images TI1 and TI2 may be similar to each other.

The user images may be extracted from the taken images TI1 and TI2 in a rough manner, as described above, and thus the user images respectively extracted from the first taken image TI1 of the child who has arms shorter than those of the adult and raises up the left arm and the second taken image TI2 of the adult who half raises up the left arm may represent similar arm lengths and arm shapes even though the first and second taken images TI1 and TI2 are different from each other.

Referring back to FIG. 13, the body shape information of the user U is loaded in operation S32. The body shape information is acquired through the aforementioned process and may be stored in the memory 160 shown in FIG. 1. Accordingly, the body shape information corresponding to the user U who is currently using the display device 100 can be searched and loaded.

Subsequently, the user's gesture is recognized based on the body shape information in operation S34 and the recognized user's gesture is specified in operation S36.

Referring to FIG. 15, the controller 180 shown in FIG. 1 may have the user image UI. The controller 180 shown in FIG. 1 can measure the arm length or height from the user image UI. Though there are various information items that can be obtained through the user information UI, the description of the present embodiment will be made on the assumption that the arm length of the user is 40 cm.

While the required information is acquired from the user image UI, the body shape information about the user U can be loaded from the memory 160 shown in FIG. 1. If the height of the user is 130 cm, the arm length of the user can be estimated as 40 cm through the table shown in FIG. 8 (b), and thus the threshold of an arm gesture of the user can be set to 40. Although the threshold can be increased or decreased in consideration of error, the estimated arm length is used as the threshold in the present embodiment. Since the measured arm length AL exceeds the threshold corresponding to the user, the controller 180 shown in FIG. 1 can determine that the user raises up the left arm.

When the height of the user in the user image UI is 180 cm, the arm length of the user is estimated to be 70 cm through the table shown in FIG. 8 (b). In this case, the threshold of an arm gesture can be set to 70. The threshold can be adjusted as described above. Since the actually measured arm length AL is 40 while the threshold of the arm gesture is 70, the controller 180 shown in FIG. 1 can determine that the user does not completely raise up the left arm. Consequently, the controller 180 shown in FIG. 1 can compare the measured value to the threshold obtained from the body shape information of the user to correctly recognize the gesture of the user even when the user image UI of the user is similar to user images of other users.

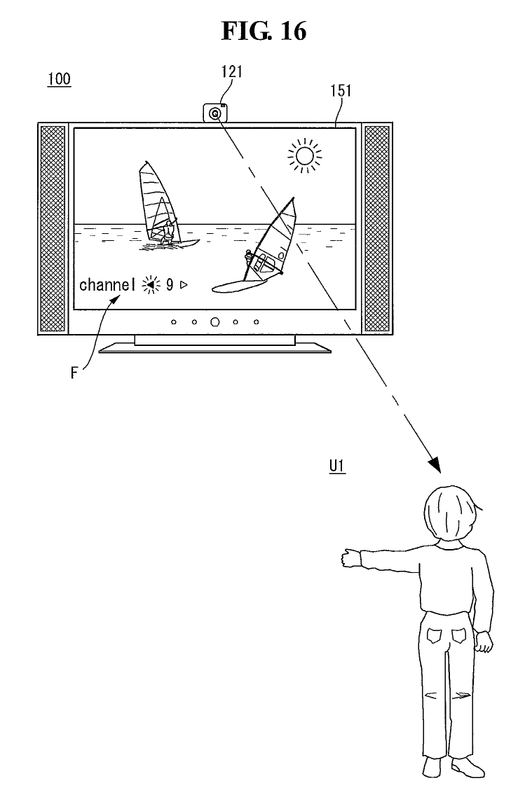

FIGS. 16, 17 and 18 are views for explaining a function mapped to a user's gesture.

When the user's gesture is recognized based on the body shape information of the user, the function mapped to the gesture may be executed in step S40 shown in FIG. 2.

Referring to FIG. 16, a first user U1 may make a gesture of raising up the left arm. The first user U1 may be a relatively small child, and thus the left arm of the first user U1 may be short. Even in this case, the display device 100 can acquire the body shape information of the first user U1 from the height of the first user U1 and correctly recognize the gesture of the first user U1. Since the first user U1 make a specific gesture in correct posture, the display device 100 can execute the channel change function corresponding to the gesture.

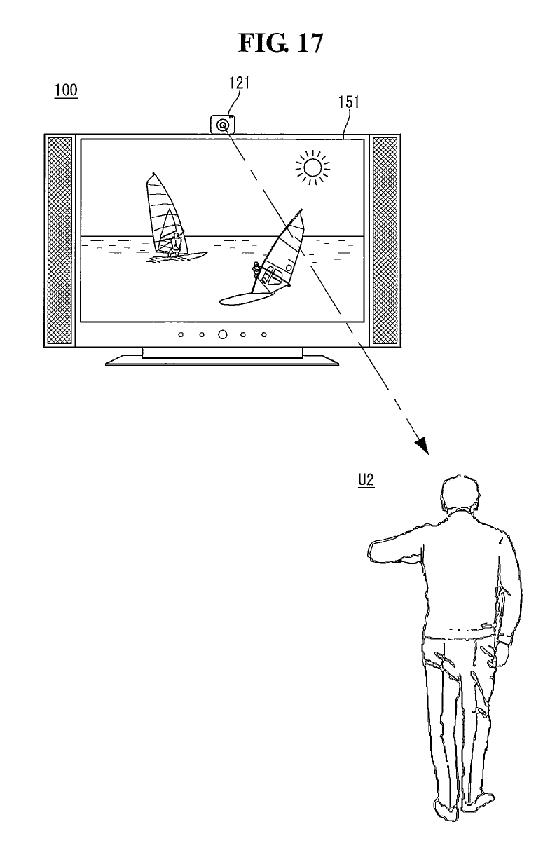

Referring to FIG. 17, a second user U2 may make a gesture of half raising up the left arm. This gesture may not be correct when determined based on the body shape information of the second unit U2, as described above. Accordingly, the display device 100 may not particularly respond to the gesture of the second user U2.

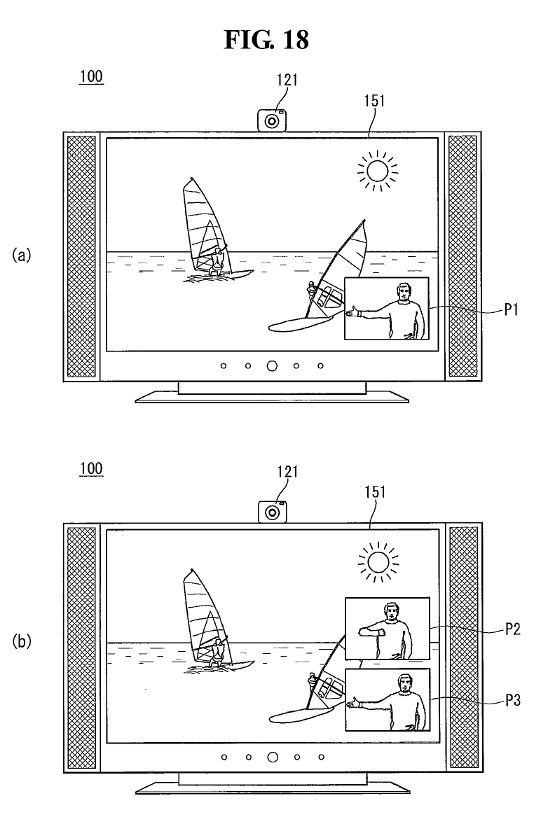

Referring to FIG. 18, the display device 100 may display an image which induces the second user U2 to make a correct gesture.

Referring to FIG. 18 (a), the display device 100 can display a correct example of the gesture which can be estimated to be a gesture the second user U2 intends to make through a pop-up window P1. That is, when the second user U2 makes the gesture of half raising up the left arm, the controller 180 shown in FIG. 1 can display the correct gesture most similar to the current gesture of the second user U2 on the first pop-up window P1. Accordingly, even if the second user U2 does not know the correct gesture, he/she can make the correct gesture with reference to the image displayed on the first pop-up window P1 to execute the function of the display device 100.

Referring to FIG. 18 (b), the display device 100 may display the image captured through the camera 121 in a second pop-up window P2 and display a correct gesture most similar to the current gesture of the second user U2 in a third pop-up window P3. That is, the display device 100 can display the current gesture of the user U2 and the correct gesture together to induce the user U2 to make a correct gesture.

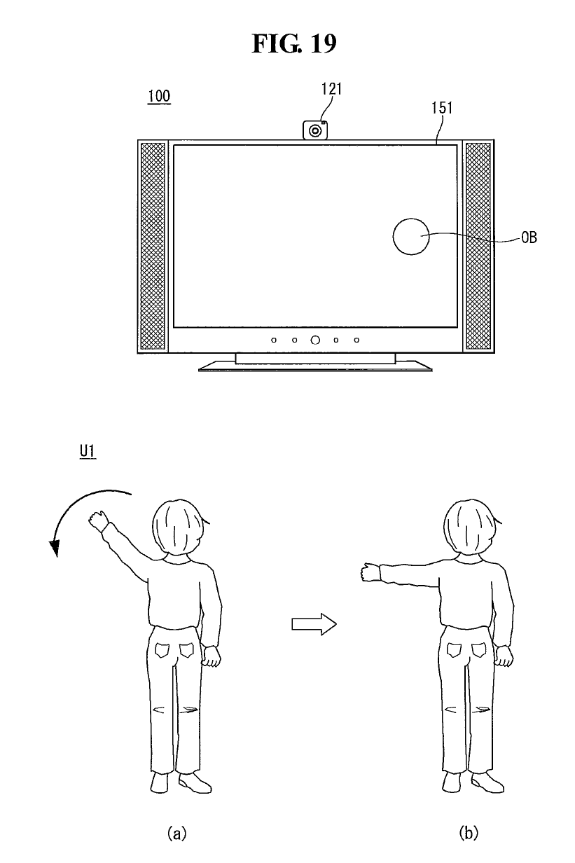

FIGS. 19, 20 and 21 are views for explaining the operation of executing the mapped function, shown in FIG. 2.

Referring to FIG. 19, the first user U1 may make a specific gesture in front of the display device 100. For example, the first user U1 turns the left arm counter clockwise to move an object OB displayed on the display 151. When the first user U1 has a small frame, however, the object OB displayed on the display 151 may be moved by only a small range even though the first user U1 makes a large gesture. In this case, the object OB can be properly moved irrespective of the body size by using the body shape information of the user.

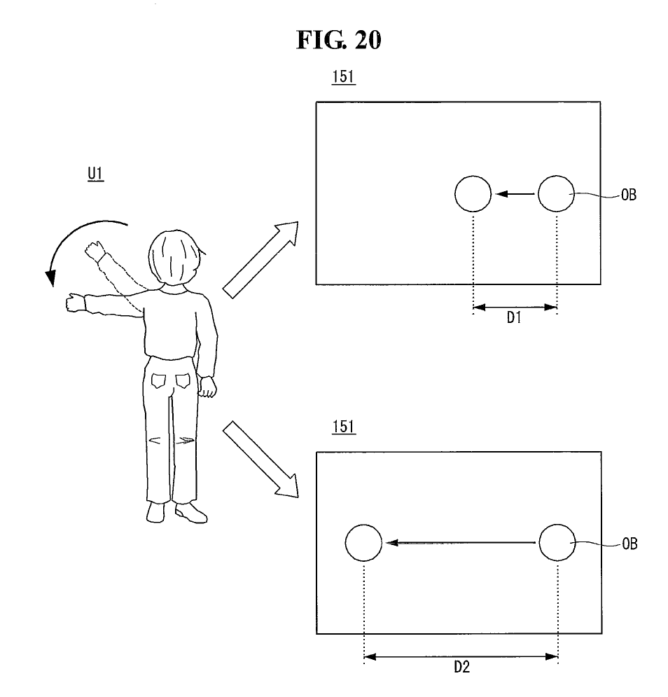

Referring to FIG. 20, if the first user U1 turns the left arm counter clockwise, two cases can be considered. That is, the display device 100 can consider the case of moving the object OB without using the body shape information of the first user U1 and the case of moving the object OB using the body shape information.

In the case of moving the object OB without using the body shape information, the display device 100 can display the object OB such that the object OB is moved by a first distance D1, which his a relatively short distance, for the gesture of the first user U1 who has a relatively small frame.

In the case of moving the object OB using the body shape information, the display device 100 can determine that the first user U1 make a large gesture based on the body shape information of the first user U1. Accordingly, the display device 100 can display the object OB such that the object OB is moved by a second distance D2 which is a relatively long distance.

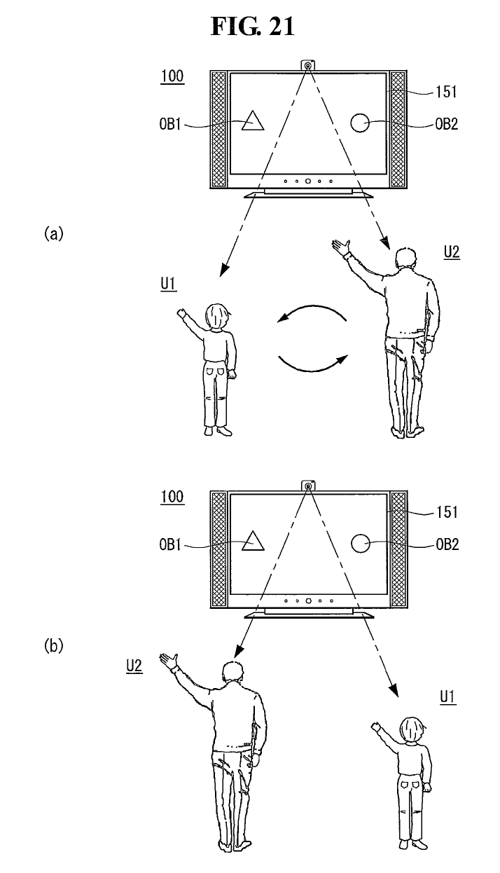

Referring to FIG. 21, functions mapped to gestures of the two users U1 and U2 can be simultaneously executed.

Referring to FIG. 21 (a), the display device 100 can simultaneously recognize the gestures of the first and second users U1 and U2 and respectively give the authorities to control first and second objects OB1 and OB2 to the first and second users U1 and U2. In this case, the display device 100 can respectively load the body shape information of the first and second users U1 and U2 and recognize the gestures of the first and second users U1 and U2. That is, the display device 100 can analyze the gesture of the first user U1 having a small frame and the gesture of the second user U2 having a large frame based on the frames of the first and second users U1 and U2 to move the first and second objects OB1 and OB2 in appropriate ranges. Furthermore, the display device 100 can trace the first and second users U1 and U2 to recognize the gestures of the first and second users U1 and U2.

Referring to FIG. 21 (b), the first and second users U1 and U2 may change their positions. Even in this case, the controller 180 of the display device 100, shown in FIG. 1, can trace the first and second users U1 and U2 using the body shape information of the first and second users U1 and U2, stored in the display device 100. That is, the controller 180 shown in FIG. 1 can trace the first and second users U1 and U2 based on the body shape characteristics of the first and second users U1 and U2 to allow the first and second users U1 and U2 to maintain the authorities to control the first and second objects OB1 and OB2 even when the first and second users U1 and U2 change their positions.

Although FIG. 21 illustrates that the first and second users U1 and U2 respectively have the authorities to control the first and second objects OB1 and OB2, the first and second users U1 and U2 can alternately have the authority to control a single object. For example, when the object is a ball, the first user U1 can make a gesture of throwing the ball and the second user U2 can make a gesture of catching the ball.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of this document. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device comprising:
a camera obtaining an image including a gesture of a user; and
a controller extracting the image of the gesture from the obtained image and executing a function mapped to the extracted gesture when the range of the gesture exceeds a threshold corresponding to the user.

2. The display device of claim 1, wherein the controller acquires information on the body shape of the user from the extracted gesture image and sets the threshold based on the acquired body shape information.

3. The display device of claim 2, wherein the body shape information corresponds to the distribution of the area occupied by the extracted gesture image and the threshold corresponds to the center point at which the area distribution equilibrates.

4. The display device of claim 2, wherein the body shape information corresponds to at least one of the height, arm length, leg length, shoulder width and head side of the user and the threshold is set in proportion to at least one of the height, arm length, leg length, shoulder width and head side of the user.

5. The display device of claim 2, wherein the body shape information corresponds to at least one of the distance between gesture points set on joints of the user and a relative position variation between the gesture points and the threshold is set in proportion to at least one of the distance between gesture points set on joints of the user and a relative position variation between the gesture points.

6. The display device of claim 2, wherein there are multiple users and the controller sets thresholds for the respective users based on the respective body shape information of the users.

7. The display device of claim 6, wherein the controller respectively acquires images of the users based on the body shape information of the users.

8. The display device of claim 1, wherein the controller displays a gesture that is similar to the extracted gesture and has a range exceeding the threshold on a display when the range of the extracted gesture does not reach the threshold.

9. The display device of claim 1, wherein the function corresponds to at least one of changing a channel, controlling volume, changing setting and changing the position of an object displayed on the display.

10. A display device comprising:
a camera obtaining images including gestures of users; and
a controller respectively extracting the images of the gestures of the users from the obtained images and executing functions respectively mapped to the gestures when the ranges of the extracted gestures exceed thresholds respectively corresponding to the users.

11. The display device of claim 10, wherein the controller respectively acquires information on the body shapes of the users from the extracted gestures and sets the thresholds based on the acquired body shape information.

12. The display device of claim 11, wherein the controller acquires the images with respect to the users based on the body shape information of the users.

13. A method of controlling a display device, comprising:
obtaining an image including a gesture of a user;
extracting the gesture from the obtained image; and
executing a function mapped to the extracted gesture when the range of the extracted gesture exceeds a threshold corresponding to the user.

14. The method of claim 13, wherein the acquiring of the information on the body shape of the user from the extracted gesture comprises setting the threshold based on the acquired body shape information.

15. The method of claim 14, wherein the body shape information corresponds to the distribution of the area occupied by the extracted gesture image and the threshold corresponds to the center point at which the area distribution equilibrates.

16. The method of claim 14, wherein the body shape information corresponds to at least one of the height, arm length, leg length, shoulder width and head side of the user and the threshold is set in proportion to at least one of the height, arm length, leg length, shoulder width and head side of the user.

17. The method of claim 14, wherein the body shape information corresponds to at least one of the distance between gesture points set on joints of the user and a relative position variation between the gesture points and the threshold is set in proportion to at least one of the distance between gesture points set on joints of the user and a relative position variation between the gesture points.

18. The method of claim 14, wherein there are multiple users and thresholds are respectively set based on the body shape information of the users.

19. The method of claim 18, wherein images are respectively acquired for the users based on the body shape information of the users.

20. The method of claim 13, further comprising:
receiving the body shape information of the user; and
setting the threshold based on the received body shape information.

21. The method of claim 13, further comprising displaying a gesture that is similar to the extracted gesture and has a range exceeding the threshold corresponding to the user when the range of the extracted gesture does not reach the threshold.

22. The method of claim 13, wherein the function corresponds to at least one of changing a channel, controlling volume, changing setting and changing the position of an object displayed on the display device.

23. A method of controlling a display device, comprising:
obtaining images including gestures of users; and
respectively extracting the gestures of the users from the obtained images; and
executing functions respectively mapped to the extracted gestures when the ranges of the extracted gestures exceed thresholds respectively corresponding to the users.

24. The method of claim 23, further comprising:
respectively acquiring information on the body shapes of the users from the extracted gestures; and
setting the thresholds based on the acquired body shape information.

25. The method of claim 24, wherein the acquiring of the images comprises acquiring the images with respect to the users based on the body shape information of the users.
